(19) United States
(12) Patent Application Publication
(10) Pub. No.: US 2019/0315321 A1
(43) Pub. Date: Oct. 17, 2019

(54) VEHICLE CONTROL APPARATUS AND VEHICLE CONTROL METHOD

(71) Applicant: MANDO CORPORATION, Pyeongtaek-si (KR)

(72) Inventor: Chan Won Lee, Uiwang-si (KR)

(21) Appl. No.: 16/382,347

(22) Filed: Apr. 12, 2019

(30) Foreign Application Priority Data
Apr. 13, 2018 (KR) 10-2018-0043245

(51) Int. Cl. B60T 7/12; F16H 63/48

(52) U.S. Cl. CPC B60T 7/12; F16H 63/483; B60T 2250/04; B60T 2210/20; B60T 2220/04; B60T 2210/10; B60T 2240/00

(57) ABSTRACT

Provided is a vehicle control apparatus and vehicle control method. The vehicle control apparatus and vehicle control method includes a sensing unit configured to sense at least one of a vehicle speed value and a wheel speed value, a transmission information output device configured to output transmission information, and a control unit configured to determine whether a vehicle having been in a stationary state is moving using the sensed at least one of the vehicle speed value and the wheel speed value, determine whether the output transmission information corresponds to a neutral state when the vehicle having been in a stationary state is moving, and transmit an electrical parking brake (EPB) engagement command to an EPB device such that EPB automatic engagement is performed by the EPB device when the transmission information corresponds to a neutral state.

### CROSS-REFERENCE TO RELATED APPLICATION

This application is based on and claims priority under 35 U.S.C. § 119 to Korean Patent Application No. 2018-0043245, filed on Apr. 13, 2018 in the Korean Intellectual Property Office, the disclosure of which is incorporated herein by reference.

### BACKGROUND

### 1. Field

The present invention relates to a vehicle control apparatus and a vehicle control method.

### 2. Description of the Related Art

In general, the conventional electronic parking brake device, as a driver-friendly automatic brake device, has a brake automatically operated when the ignition is turned off, and has the brake automatically released when the ignition is turned on and an accelerator is applied so that the convenience of parking is improved.

For example, Korean Registered Patent No. 10-1303757 (Aug. 29, 2013) discloses an auto vehicle holding apparatus and method capable of maintaining braking power in a stationary state of a vehicle using an electronic parking brake device.

However, the conventional auto vehicle holding apparatus and method have limitation in effectively performing EPB automatic engagement of an EPB device in response to existence of a gradient, which leads to limitation in preventing a fender bender.

In recent years, studies have been continuously conducted on an improved vehicle control apparatus and method for effectively preventing occurrence of a fender bender by effectively performing EPB automatic engagement of the EPB device in response to existence of a gradient.

Further, in recent years, studies have been continuously conducted on an improved vehicle control apparatus and method for improving the reliability of a vehicle by suppressing the anxiety over an EPB operation state felt by the driver.

Further, in recent years, studies have been conducted on an improved vehicle control apparatus and method for reducing an increase in maintenance costs by rapidly performing an initial response for maintenance of an auto vehicle holding device.

### RELATED ART DOCUMENT

### Patent Document

(Patent Document) Korean Registered Patent NO. 10-1303757 (2013.08.29)

### SUMMARY

Therefore, it is an object of the present invention to provide a vehicle control apparatus and method capable of preventing fender bender from occurring.

It is another object of the present invention to provide a vehicle control apparatus and method capable of effectively performing EPB automatic engagement of an EPB device.

It is another object of the preset invention to provide a vehicle control apparatus and method capable of improving the reliability of a vehicle by suppressing the anxiety over an EPB operation state.

It is another object of the present invention to provide a vehicle control apparatus and method capable of reducing increase in the maintenance cost by rapidly performing an initial response for maintenance of an auto vehicle holding device

Additional aspects of the invention will be set forth in part in the description which follows and, in part, will be obvious from the description, or may be learned by practice of the invention.

Therefore, it is an aspect of the present invention to provide a vehicle control apparatus including: a sensing unit configured to sense at least one of a vehicle speed value and a wheel speed value; a transmission information output device configured to output transmission information; and a control unit configured to determine whether a vehicle having been in a stationary state is moving using the sensed at least one of the vehicle speed value and the wheel speed value, determine whether the output transmission information corresponds to a neutral state when the vehicle having been in a stationary state is moving, and transmit an electrical parking brake (EPB) engagement command to an EPB device such that EPB automatic engagement is performed by the EPB device when the transmission information corresponds to a neutral state.

The control unit, when determining whether the transmission information corresponds to a neutral state, may determine whether the output transmission information corresponds to a set automatic transmission type neutral state.

The control unit, when determining whether the transmission information corresponds to a neutral state, may determine whether the output transmission information corresponds to a set manual transmission type neutral state.

The control unit, when determining whether the vehicle having been in a stationary state is moving, may determine whether the sensed at least one of the vehicle speed value and the wheel speed value is equal to a set target value corresponding thereto.

The control unit may further receive a braking value from a conventional brake (CB) device, and further determine whether the received braking value is kept for a preset target time or longer.

The control unit may further receive an accelerator pedal operation signal sensed by the sensing unit, and further determine whether an accelerator pedal is in a non-operation state using the received accelerator pedal operation signal.

The control unit may further receive a change value of longitudinal acceleration sensed by the sensing unit, and further determine whether a change in longitudinal acceleration exists using the received change value of longitudinal acceleration.

The control unit may further transmit an EPB engagement command to the EPB device such that EPB automatic engagement is performed by the EPB device when a change in longitudinal acceleration exists.

The control unit may further receive an auto vehicle holding operation signal from an auto vehicle holding device, and further determine whether auto vehicle holding is not performed using the received auto vehicle holding operation signal.

The control unit may further transmit an EPB engagement command to the EPB device such that EPB automatic engagement is performed by the EPB device when auto vehicle holding is not performed.

The control unit may further receive road surface information sensed by the sensing unit, and further determine whether a road surface has a gradient using the received road surface information.

It is another object of the present invention to provide a vehicle control method including: sensing at least one of a vehicle speed value and a wheel speed value; determining whether a vehicle having been in a stationary state is moving using the at least one of the vehicle speed value and the wheel speed value; receiving transmission information output from a transmission information output device when the vehicle having been in a stationary state is moving; determining whether the received transmission information corresponds to a neutral state; and transmitting an electrical parking brake (EPB) engagement command to an EPB device such that EPB automatic engagement is performed by the EPB device when the transmission information corresponds to a neutral state.

The determining of whether the vehicle having been in a stationary state is moving may include determining whether the sensed at least one of the vehicle speed value and the wheel speed value is equal to a set target value corresponding thereto.

The vehicle control method may further include: receiving a braking value output from a conventional brake (CB) device when the vehicle having been in a stationary state is moving; and determining whether the received braking value is kept for a preset target time or longer.

The vehicle control method may further include: receiving an accelerator pedal operation signal when the transmission information corresponds to a neutral state; and determining whether an accelerator pedal is in a non-operation state using the sensed accelerator pedal operation signal.

The vehicle control method may further include sensing a change value of longitudinal acceleration when the accelerator pedal is in a non-operation state; and determining whether a change in longitudinal acceleration exists using the sensed change value of longitudinal acceleration.

The vehicle control method may further include transmitting an EPB engagement command to the EPB device such that EPB automatic engagement is performed by the EPB device when a change in longitudinal acceleration exists.

The vehicle control method may further include: receiving an auto vehicle holding operation signal from an auto vehicle holding device when the transmission information corresponds to a neutral state; and determining whether auto vehicle holding is not performed using the received auto vehicle holding operation signal.

The vehicle control method may further include transmitting an EPB engagement command to the EPB device such that EPB automatic engagement is performed by the EPB device when auto vehicle holding is not performed.

The vehicle control method may further include: receiving road surface information before the determining of whether the vehicle having been in a stationary state is moving; and determining whether a road surface has a gradient using the sensed road surface information.

### BRIEF DESCRIPTION OF THE DRAWINGS

These and/or other aspects of the invention will become apparent and more readily appreciated from the following description of the embodiments, taken in conjunction with the accompanying drawings of which:

FIG. 1 is a block diagram illustrating an example of a vehicle control apparatus according to an embodiment of the present invention;

FIG. 2 is a flowchart showing an example of a vehicle control method of a vehicle control apparatus according to an embodiment of the present invention;

FIG. 3 and FIG. 4 are flowcharts showing another example of a vehicle control method of a vehicle control apparatus according to an embodiment of the present invention;

FIG. 5 is a block diagram illustrating another example of a vehicle control apparatus according to an embodiment of the present invention;

FIG. 6 is a flowchart showing another example of a vehicle control method of a vehicle control apparatus according to an embodiment of the present invention;

FIG. 7 is a block diagram illustrating another example of a vehicle control apparatus according to an embodiment of the present invention;

FIG. 8 is a flowchart showing another example of a vehicle control method of a vehicle control apparatus according to an embodiment of the present invention;

FIG. 9 is a block diagram illustrating another example of a vehicle control apparatus according to an embodiment of the present invention;

FIG. 10 is a block diagram illustrating another example of a vehicle control apparatus according to an embodiment of the present invention;

FIG. 11 is a block diagram illustrating another example of a vehicle control apparatus according to an embodiment of the present invention;

FIG. 12 is a flowchart showing another example of a vehicle control method of a vehicle control apparatus according to an embodiment of the present invention;

FIG. 13 is a flowchart showing another example of a vehicle control method of a vehicle control apparatus according to an embodiment of the present invention;

FIG. 14 is a flowchart showing another example of a vehicle control method of a vehicle control apparatus according to an embodiment of the present invention; and

FIG. 15 is a flowchart showing another example of a vehicle control method of a vehicle control apparatus according to an embodiment of the present invention.

### DETAILED DESCRIPTION

Hereinafter, embodiments of the present invention will be described in detail with reference to the accompanying drawings. The following embodiments are provided to fully convey the spirit of the present invention to skilled in the art to which the present invention pertain. The present invention is not limited to the embodiments disclosed below, but may be embodied in other forms. In order to make the description of the present invention clear, unrelated parts are not shown, and the sizes of some components may be exaggerated to aid in the understanding of the present invention.

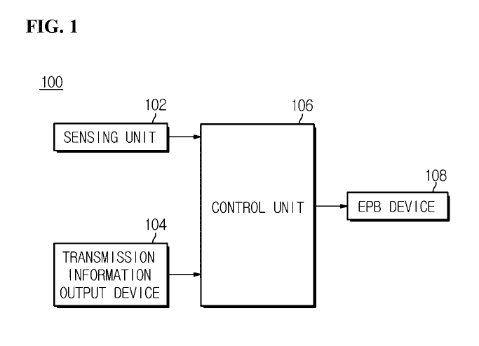

FIG. 1 is a block diagram illustrating an example of a vehicle control apparatus 100 according to an embodiment of the present invention.

Referring to FIG. 1, the vehicle control apparatus 100 according to an embodiment of the present invention includes a sensing unit 102, a transmission information output device 104, a control unit 106, and an electrical parking brake (EPB) device 108.

The sensing unit 102 senses at least one of a vehicle speed value and a wheel speed value, and the transmission information output device 104 outputs transmission information.

Although not shown, the sensing unit 102 may include a vehicle speed sensor (not shown) for sensing a vehicle speed value, and may include a wheel speed sensor (not shown) for sensing a wheel speed value.

In this case, the transmission information output device 104 may include a controller area network (CAN) BUS (not shown), and the CAN bus (not shown) may include vehicle specification information, and the vehicle specification information may include transmission information.

In addition, the sensing unit 102 may further detect road surface information.

The sensing unit 102 may include a road surface sensor (not shown) for sensing road surface information, and a longitudinal gravitational acceleration sensor (not shown) for sensing a gradient state of road surface information.

The control unit 106 determines whether the vehicle having been in a stationary state is moving using at least one of a vehicle speed value and a wheel speed value sensed by the sensing unit 102.

For example, when determining whether the vehicle having been in a stationary state is moving, the control unit 106 may determine whether at least one of a vehicle speed value and a wheel speed value sensed by the sensing unit 102 is a set target value corresponding thereto.

For example, when determining whether the vehicle having been in a stationary state is moving, the control unit 106 may determine whether the vehicle speed value sensed by the sensing unit 102 is equal to or greater than a set target vehicle speed value of “1”, and may determine whether the wheel speed value sensed by the sensing unit 102 is equal to or greater than a set target wheel speed value of “1”.

When it is determined that the vehicle having been in a stationary state is moving, the control unit 106 determines whether the transmission information output from the transmission information output device 104 corresponds to a neutral state.

For example, when determining whether the transmission information corresponds to a neutral state, the control unit 106 may determine whether the transmission information output from the transmission information output device 104 corresponds to a set automatic transmission type neutral state.

Alternatively, when determining whether the transmission information corresponds to a neutral state, the control unit 106 may determine whether the transmission information output from the transmission information output device 104 corresponds to a set manual transmission type neutral state.

Further, the control unit 106 may further receive road surface information sensed by the sensing unit 102, and further determine whether the road surface has a gradient using the received road surface information.

When it is determined that the transmission information corresponds to a neutral state, the control unit 106 transmits an EPB engagement command to the EPB device 108 such that EPB automatic engagement is performed by the EPB device 108.

The control unit 106 of the vehicle control apparatus 100 according to an embodiment of the present invention may further receive an accelerator pedal operation signal sensed by the sensing unit 102, and may further determine whether an accelerator pedal is in a non-operation state using the received accelerator pedal operation signal.

For example, when the received accelerator pedal operation signal is determined to be an Off operation signal, the control unit 106 may further determine that the accelerator pedal is in a non-operation state.

The control unit 106 of the vehicle control apparatus 100 according to an embodiment of the present invention may further receive a change value of longitudinal acceleration sensed by the sensing unit 102, and may further determine an existence of a change in longitudinal acceleration using the received change value of longitudinal acceleration.

For example, when the received change value of longitudinal acceleration is determined to exist for a predetermined time, the control unit 106 may further determine that a change in longitudinal acceleration exists.

In this case, when it is determined that a change in longitudinal acceleration exists, the control unit 106 may further transmit an EPB engagement command to the EPB device 108 such that EPB automatic engagement is performed by the EPB device 108.

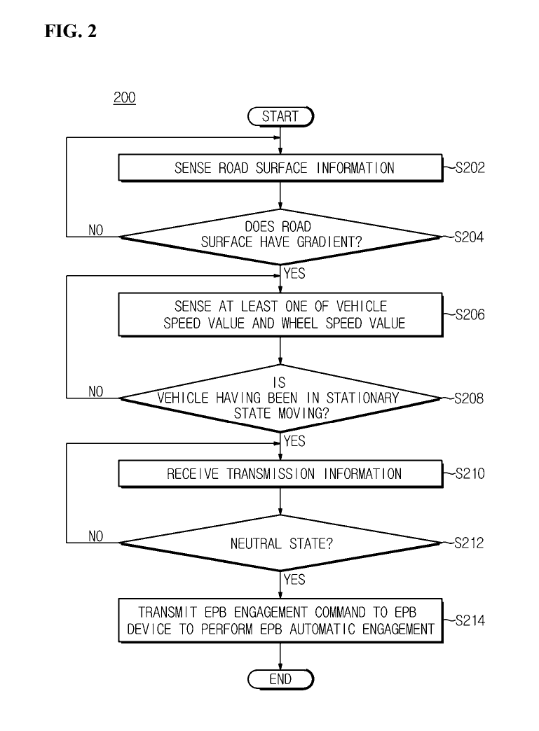

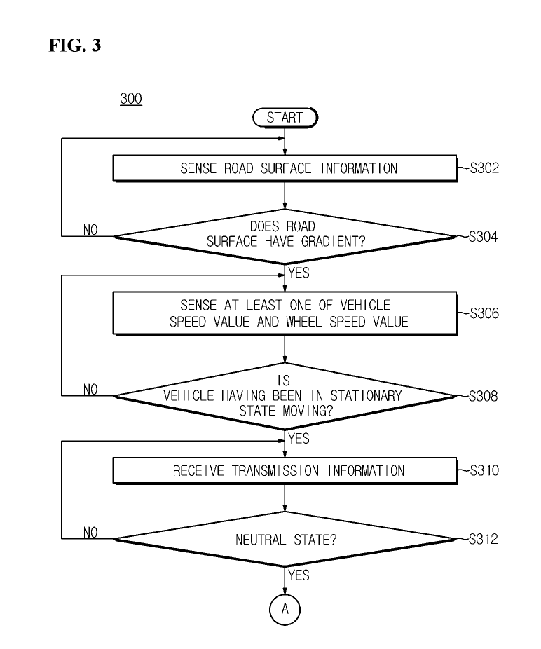

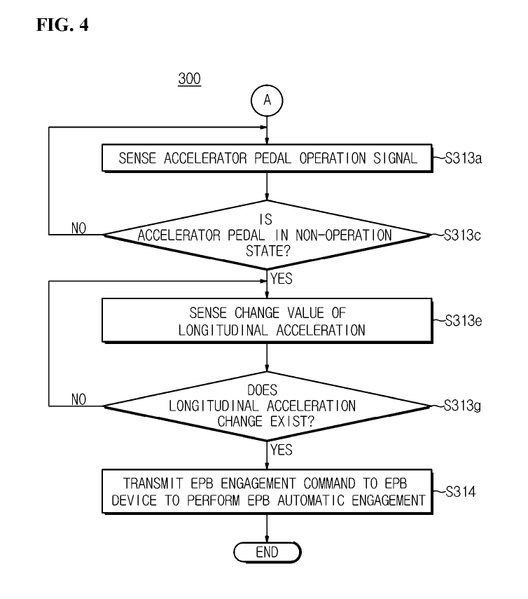

FIG. 2 is a flowchart showing an example of a vehicle control method (200) of a vehicle control apparatus according to an embodiment of the present invention, and FIG. 3 and FIG. 4 are flowcharts showing another example of a vehicle control method (300) of a vehicle control apparatus according to an embodiment of the present invention.

Referring to FIGS. 2 to 4, the vehicle control methods (200) and (300) of the vehicle control apparatus 100 of FIG. 1 according to the embodiment of the present invention may include operations (S206 and S208) and (S306 and S308) correspond to a second operation in a respective method, operations (S210 and S212) and (S310 and S312) corresponding to a third operation in a respective method, and operations (S214) and (S314) corresponding to a fourth operation in a respective method.

In the second operation (S206 or S306), at least one of the vehicle speed value and the wheel speed value is sensed by the sensing unit (102 in FIG. 1) when the control unit (106 in FIG. 1) determines that a road surface has a gradient.

In the second operation (S208 or S308), the control unit (106 in FIG. 1) determines whether the vehicle having been in a stationary state is moving using at least one of the vehicle speed value and the wheel speed value sensed by the sensing unit (102 in FIG. 1).

For example, in the second operation (S208 or S308), when the control unit (106 in FIG. 1) determines whether the vehicle having been in a stationary state is moving, the control unit (106 in FIG. 1) may determine whether at least one of a vehicle speed value and a wheel speed value sensed by the sensing unit (102 in FIG. 1) is a set target value corresponding thereto.

In the third operation (S210 or S310), when the control unit (106 in FIG. 1) determines that the vehicle having been in a stationary state is moving, the control unit (106 in FIG. 1) receives transmission information output from the transmission information output device (104 in FIG. 1).

In the third operation (S212 or S312), the control unit (106 in FIG. 1) determines whether the received transmission information corresponds to a neutral state.

For example, in the third operation (S212 or S312), when the control unit (106 in FIG. 1) determines whether the transmission information corresponds to a neutral state, the control unit (106 in FIG. 1) may determine whether the received transmission information corresponds to an automatic transmission type neutral state that is set in the control unit (106 in FIG. 1).

Alternatively, in the third operation (S212 or S312), when the control unit (106 in FIG. 1) determines whether the transmission information corresponds to a neutral state, the control unit (106 in FIG. 1) may determine whether the received transmission information corresponds to a manual transmission type neutral state that is set in the control unit (106 in FIG. 1).

In the fourth operation (S214), when it is determined that the transmission information corresponds to a neutral state, the control unit (106 in FIG. 1) may transmit an EPB engagement command to the EPB device (108 in FIG. 1) such that EPB automatic engagement is performed by the EPB device 108.

The vehicle control methods (200) and (300) of the vehicle control apparatus 100 of FIG. 1 according to the embodiment of the present invention may further include operations (S202 and S204) and (S302 and S304) corresponding to a first operation in a respective method.

The first operation (S202 and S204) and (S302 and S304) may be performed before the second operation (S206 and S208) and (S306 and S308).

In the first operation (S202 or S302), the road surface information may be sensed by the sensing unit (102 in FIG. 1).

In the first operation (S204 or S304), the control unit (106 in FIG. 1) may determine whether the road surface has a gradient using the road surface information sensed by the sensing unit (102 in FIG. 1).

Referring to FIG. 4, the vehicle control method (300) of the vehicle control apparatus (100 in FIG. 1) according to the embodiment of the present invention may further include operations (S313a, S313c, S313e, and S313g) corresponding to the third operation.

In the third operation (S313a), when the control unit (106 in FIG. 1) determines that the transmission information corresponds to a neutral state, an accelerator pedal operation signal may be sensed by the sensing unit (102 in FIG. 1).

In the third operation S313c, the control unit (106 in FIG. 1) may determine whether the accelerator pedal is in a non-operation state using the accelerator pedal operation signal sensed by the sensing unit (102 in FIG. 1).

In the third operation S313e, when the control unit (106 in FIG. 1) determines that the accelerator pedal is in a non-operation state, a change value of longitudinal acceleration may be sensed by the sensing unit (102 in FIG. 1).

In the third operation S313g, the control unit (106 in FIG. 1) may determine whether a change in longitudinal acceleration exists using the change value of longitudinal acceleration sensed by the sensing unit (102 in FIG. 1).

In the fourth operation (S314), when the control unit (106 in FIG. 1) determines that a change in longitudinal acceleration exists, the control unit (106 in FIG. 1) may further transmit an EPB engagement command to the EPB device (108 in FIG. 1) such that EPB automatic engagement is performed by the EPB device 108.

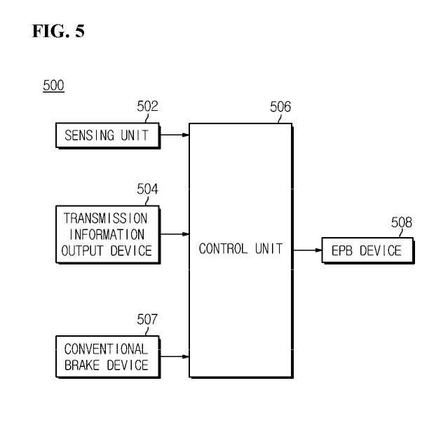

FIG. 5 is a block diagram illustrating another example of a vehicle control apparatus 500 according to an embodiment of the present invention.

Referring to FIG. 5, the vehicle control apparatus 500 according to the embodiment of the present invention includes a sensing unit 502, a transmission information output device 504, a control unit 506, and an electrical parking brake (EPB) device 508, similar to the vehicle control apparatus (100 in FIG. 1) according to the above described embodiment.

In the following description, the functions and connections of components constituting the vehicle control apparatus 500, which are identical to those of the vehicle control apparatus (100 in FIG. 1) described in the above embodiment of the present invention, will be omitted.

The control unit 506 of the vehicle control apparatus 500 according to the embodiment of the present invention further receives a braking value from a conventional brake (CB) device 507, and may determine whether the received braking value is kept for a preset target time or longer.

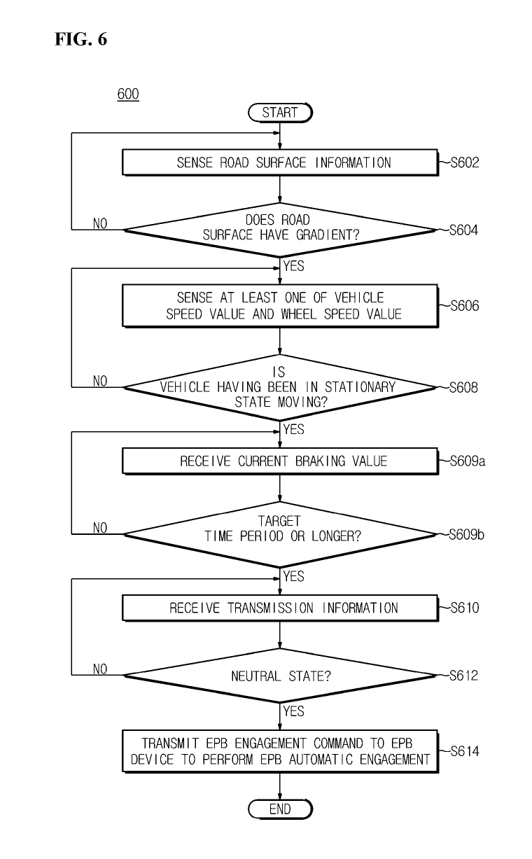

FIG. 6 is a flowchart showing another example of a vehicle control method 600 of a vehicle control apparatus according to an embodiment of the present invention.

Referring to FIG. 6, the vehicle control method 600 of the vehicle control apparatus (500 in FIG. 5) according to the embodiment of the present invention includes a second operation (S606 and S608), a third operation (S610 and S612), and a fourth operation (S614), similar to the vehicle control method (200 of FIG. 2) of the vehicle control apparatus (100 in FIG. 1).

In addition, the vehicle control method (600) of the vehicle control apparatus (500 in FIG. 5) according to the embodiment of the present invention may further include a first operation (S602 and S604) similar to the vehicle control method (200 in FIG. 2) of the vehicle control apparatus (100 in FIG. 1).

In the following description, the functions and connections of operations constituting the vehicle control method (600) of the vehicle control apparatus (500 in FIG. 5), which are identical to those of the vehicle control method (200 in FIG. 2) of the vehicle control apparatus (100 in FIG. 1) described in the above embodiment of the present invention, will be omitted.

In the second operation (S609a) of the vehicle control method (600) of the vehicle control apparatus (500 of FIG. 5) according to the embodiment of the present invention, when the control unit (506 in FIG. 5) determines that the vehicle having been in a stationary state is moving, the control unit (506 in FIG. 5) may further receive a braking value output from the CB device (507 in FIG. 5).

In the second operation (S609b), the control unit (506 in FIG. 5) may further determine whether the received braking value is kept for a target time or longer that is set in the control unit (506 in FIG. 5).

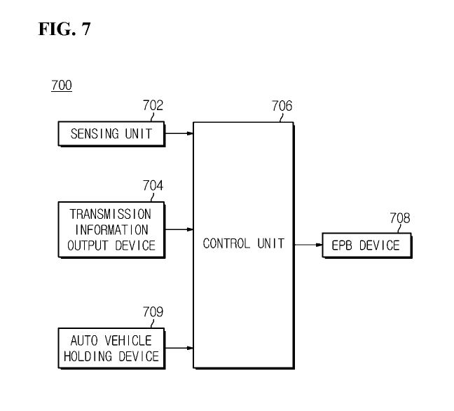

FIG. 7 is a block diagram illustrating another example of a vehicle control apparatus 700 according to an embodiment of the present invention.

Referring to FIG. 7, the vehicle control apparatus 700 according to the embodiment of the present invention includes a sensing unit 702, a transmission information output device 704, and a control unit 706, and an EPB) device 708 similar to the vehicle control device (100 in FIG. 1).

In the following description, the functions and connections of operations constituting the vehicle control apparatus 700, which are identical to those of the vehicle control apparatus (100 in FIG. 1) described in the above embodiment of the present invention, will be omitted.

The control unit 706 of the vehicle control apparatus 700 according to the embodiment of the present invention may further receive an auto vehicle holding operation signal from an auto vehicle holding device 709, and further determine whether an auto vehicle holding is not performed using the received auto vehicle holding operation signal.

For example, when the received auto vehicle holding operation signal is an FF operation signal, the control unit 706 may further determine that auto vehicle holding is not performed.

Here, the auto vehicle holding device 709 may represent tan automatic vehicle Hold (AVH) device (not shown), or a hill start assist (HSA) device (not shown) although not shown.

In this case, when it is determined that auto vehicle holding is not performed, the control unit 706 may further transmit an EPB engagement command to the EPB device 708 such that EPB automatic engagement is performed by the EPB device 708.

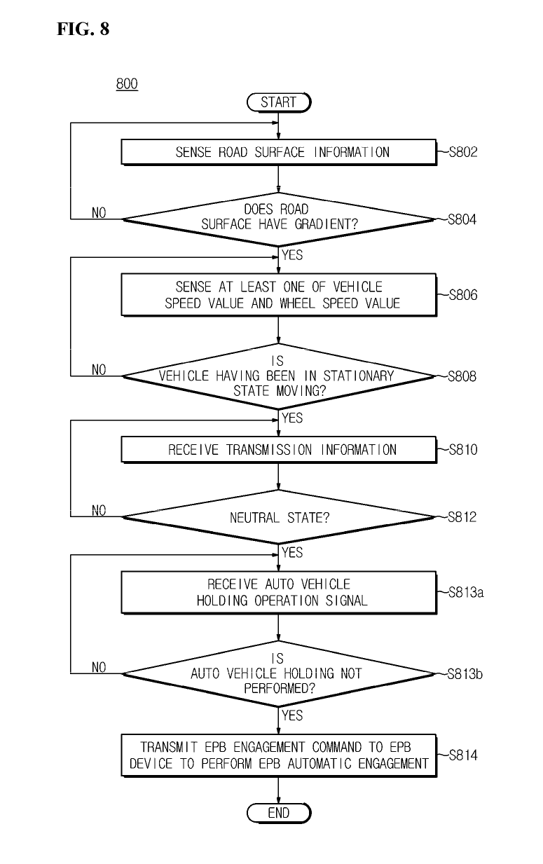

FIG. 8 is a flowchart illustrating another example of a vehicle control method 800 of a vehicle control apparatus according to an embodiment of the present invention.

Referring to FIG. 8, the vehicle control method (800) of the vehicle control apparatus (700 in FIG. 7) according to the embodiment of the present invention may include operations (S806 and S808) corresponding to a second operation, operations (S810 and S812) corresponding to a third operation), and a fourth operation (S814), similar to the vehicle control method (200 in FIG. 2) of the vehicle control apparatus (100 in FIG. 1).

In addition, the vehicle control method (800) of the vehicle control apparatus (700 of FIG. 7) according to the embodiment of the present invention may further include operations (S802 and S804) corresponding to a first operation, similar to the vehicle control method (200 of FIG. 2) of the vehicle control apparatus (100 in FIG. 1).

In the following description, the functions and connections of operations constituting the vehicle control method (800) of the vehicle control apparatus (700 in FIG. 7), which are identical to those of the vehicle control method (200 in FIG. 2) of the vehicle control apparatus (100 in FIG. 1) described in the above embodiment of the present invention, will be omitted.

In the third operation (S813a) of the vehicle control method (800) of the vehicle control apparatus (700 of FIG. 7) according to the embodiment of the present invention, the control unit (706 in FIG. 7) may further receive an auto vehicle holding operation signal from the auto vehicle holding device (709 in FIG. 7), when it is determined that the transmission information corresponds to a neutral state.

In the operation S813b, the control unit (706 in FIG. 7) may further determine whether auto vehicle holding is not performed using the received auto vehicle holding operation signal.

In the fourth operation (S814), when it is determined that auto vehicle holding is not performed, the control unit (706 in FIG. 7) may further transmit an EPB engagement command to the EPB device (708 in FIG. 7) such that EPB automatic engagement is performed by the EPB device (708 in FIG. 7).

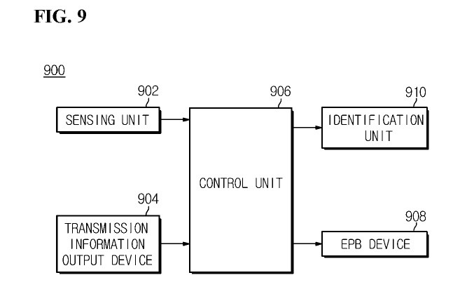

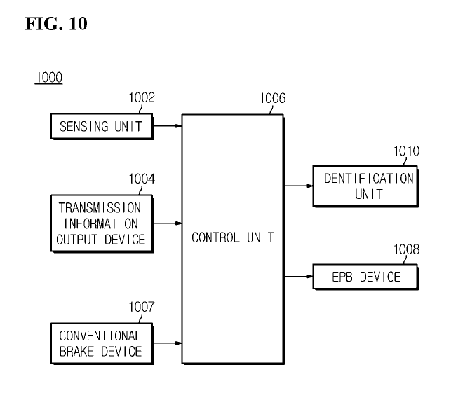

FIG. 9 is a block diagram illustrating another example of a vehicle control apparatus 900 according to an embodiment of the present invention, and FIG. 10 is a block diagram illustrating another example of a vehicle control apparatus 1000 according to an embodiment of the present invention.

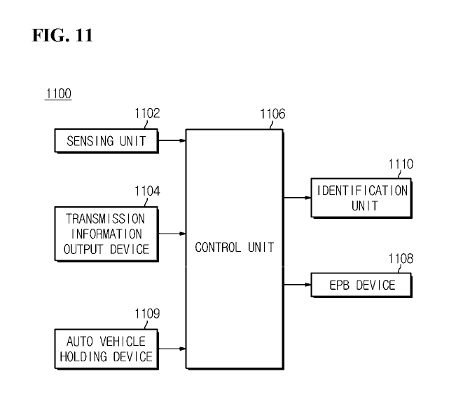

FIG. 11 is a block diagram illustrating another example of a vehicle control apparatus 1100 according to an embodiment of the present invention.

Referring to FIGS. 9 to 11, the vehicle control apparatuses 900, 1000, and 1100 according to the embodiments of the present invention include sensing units 902, 1002, and 1102, respectively, transmission information output devices 904, 1004, and 1104, respectively, control units 906, 1006, 1106, respectively, and EPB devices 908, 1008, and 1108, respectively, similar to the vehicle control apparatuses (100, 500, and 700 shown in FIGS. 1, 5, and 7).

In the following description, the functions and connections of operations constituting the vehicle control apparatuses 900, 1000, and 1100, which are identical to those of the vehicle control apparatuses (100, 500, and 700 shown in FIGS. 1, 5 and 7) described in the above embodiments of the present invention, will be omitted.

When it is determined that the transmission information corresponds to a neutral state, the control unit 906 of the vehicle control apparatus 900 according to the embodiment of the present invention may further transmit an identification command to an identification unit 910 such that the identification unit 910 identifies that EPB automatic engagement is performed.

When it is determined that a change in longitudinal acceleration exists, the control unit 1006 of the vehicle control apparatus 1000 according to the embodiment of the present invention may further transmit an identification command to an identification unit 1010 such that the identification unit 1010 identifies that EPB automatic engagement is performed.

When it is determined that auto vehicle holding is not performed, the control unit 1006 of the vehicle control apparatus 1100 according to the embodiment of the present invention may further transmit an identification command to an identification unit 1110 such that the identification unit 1110 identifies that EPB automatic engagement is performed.

When it is determined that auto vehicle holding is not performed, the control unit 1106 of the vehicle control apparatus 1100 according to the embodiment of the present invention may further transmit an identification command to the identification unit 1110 such that the identification unit 1110 identifies that auto vehicle holding is not performed.

In this case, the identification units 910, 1010, and 1110 may include at least one of an alarm (not shown), a speaker (not shown), and a light emitting member (not shown) provided for the driver to identify the information or state of the vehicle, and may identify that EPB automatic engagement is performed or that auto vehicle holding is not performed using at least one of an alarm operation of the alarm (not shown), a voice operation of the speaker (not shown), and a light emitting operation of the light emitting member (not shown).

In addition, the identification units 910, 1010, and 1110 may include a human machine interface (HMI) module (not shown) and a head-up display (HUD) module (not shown) provided for the driver to identify the information or state of the vehicle by interfacing a user and a machine, and may identify that EPB automatic engagement is performed or that auto vehicle holding is not performed using at least one of a HMI message display operation of the HMI module (not shown) and a HUD message display operation of the HUD module (not shown).

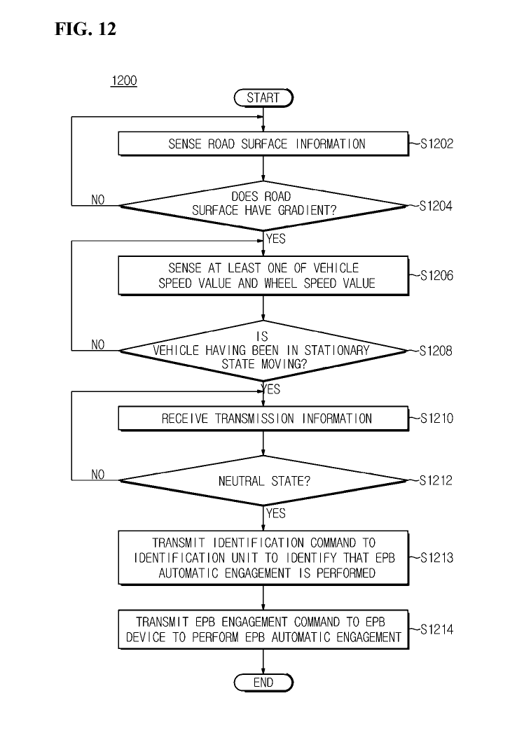

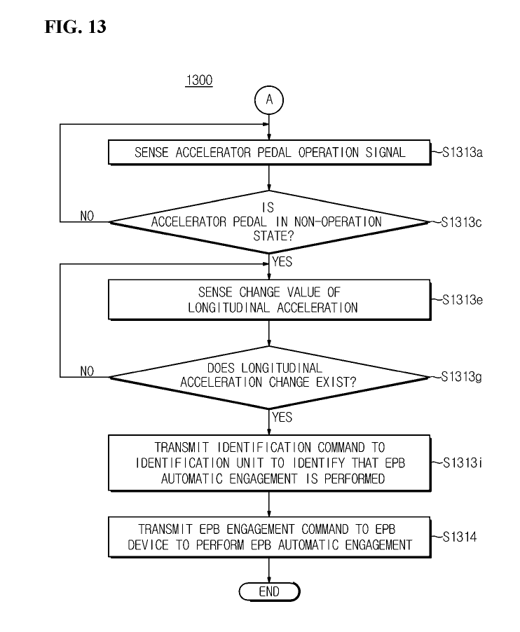

FIG. 12 is a flowchart showing another example of a vehicle control method of a vehicle control apparatus according to an embodiment of the present invention, and FIG. 13 is a flowchart showing another example of a vehicle control method of a vehicle control apparatus according to an embodiment of the present invention.

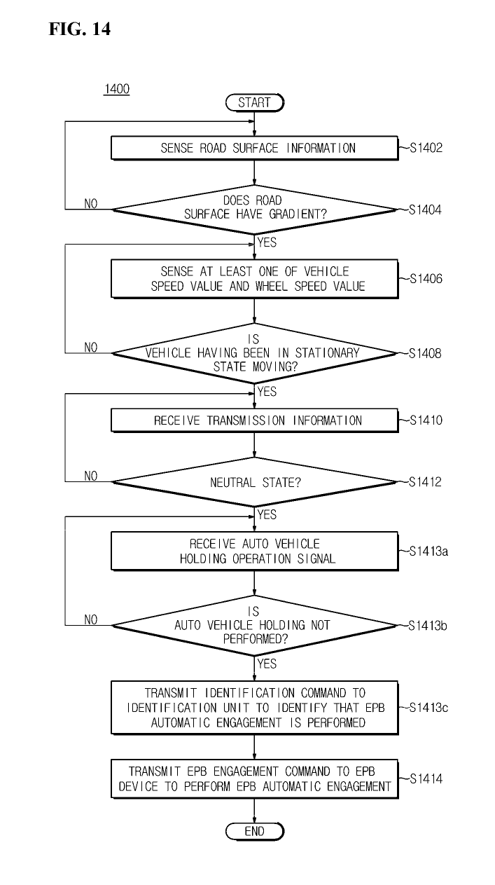

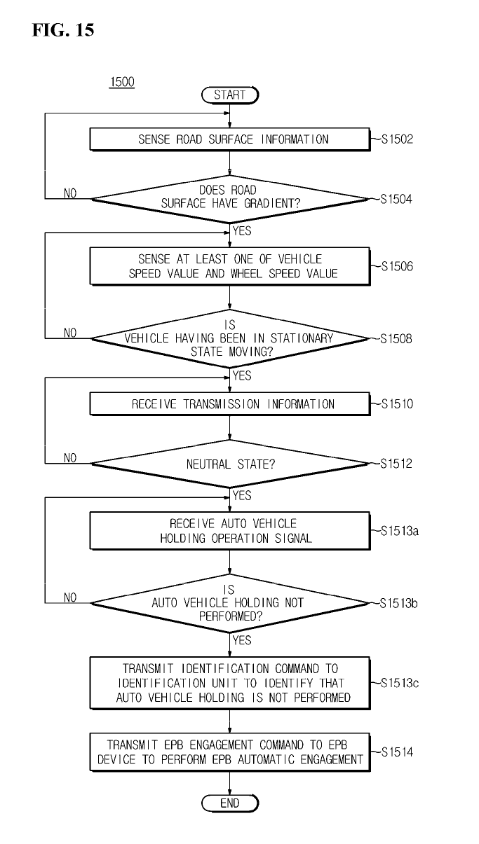

FIG. 14 is a flowchart showing another example of a vehicle control method of a vehicle control apparatus according to an embodiment of the present invention, and FIG. 15 is a flowchart showing another example of a vehicle control method for a vehicle control apparatus according to an embodiment of the present invention.

Referring to FIGS. 12 to 15, vehicle control methods (1200 to 1500) of the vehicle control apparatus (900 to 1100 of FIGS. 9 to 11) according to the embodiment of the present invention include operations (S1206 and S1208), operations (S1406 and S1408) and operations (S1506 and S1508) corresponding to a second operation in a respective method, and operations (S1210 and S1212), operations (S1313a, S1313c, S1313e, S1313g) operations (S1410, 51412, S1413a, and S1413b) and operations (S1510, S1512, S1513a, and S1513b) corresponding to a third operation in a respective method, and operations (S1214), (S1314), (S1414), and (S1514) corresponding to a fourth operation in a respective method, similar to the vehicle control methods (200, 300, and 800 in FIGS. 2, 4 and 8) of the vehicle control apparatuses (100 and 700 in FIGS. 1 and 7).

In addition, the vehicle control methods (1200 to 1500) of the vehicle control apparatuses (900 to 1100 of FIGS. 9 to 11) according to the embodiments of the present invention may include operations (S1202 and S1204), operations (S1402 and S1404), and operations (S1502 and S1504) corresponding to a first operation in a respective method, similar to the vehicle control methods (200, 300, and 800 in FIGS. 2, 4 and 8) of the vehicle control apparatuses (100 and 700 in FIGS. 1 and 7).

In the following description, the functions and connections of operations constituting the vehicle control methods (1200 to 1500) of the vehicle control apparatuses (900 to 1100 shown in FIGS. 9 to 11), which are identical to those of the vehicle control methods (200, 300, and 800 in FIGS. 2, 4 and 8) of the vehicle control apparatuses (100 and 700 in FIGS. 1 and 7) described in the above embodiment of the present invention, will be omitted.

The vehicle control methods (1200 to 1500) of the vehicle control apparatuses (900 to 1100 of FIGS. 9 to 11) according to the embodiment of the present invention may further include a first identification operation (S1213), a second identification operation (S1313i), a third identification operation (S1413c), and a fourth identification operation (S1513c).

The first identification operation (S1213) may be performed after the third operation (S1212) and before the fourth operation (S1214).

As another example, the first identification operation (S1213) may be performed in synchronization with the fourth operation (S1214).

In the first identification operation (S1213), when it is determined that the transmission information corresponds to a neutral state, the control unit (906 in FIG. 9) may further transmit an identification command to the identification unit (910 in FIG. 9) such that the identification unit 910 identifies that EPB automatic engagement is performed.

The second identification operation (S1313i) may be performed after the third operation (S1313g) and before the fourth operation (S1314).

As another example, the second identification operation (S1313i) may be performed in synchronization with the fourth operation (S1314).

In the second identification operation (S1313i), when it is determined that a change in longitudinal acceleration exists, the control unit (1006 in FIG. 10) may further transmit an identification command to the identification unit (1010 in FIG. 10) such that the identification unit (1010 in FIG. 10) identifies that EPB automatic engagement is performed.

The third identification operation (S1413c) may be performed after the third operation (S1413b) and before the fourth operation (S1414).

As another example, the third identification operation (S1413c) may be performed in synchronization with the fourth operation (S1414).

In the third identification operation (S1413c), when it is determined that auto vehicle holding is not performed, the control unit (1106 in FIG. 11)_may further transmit an identification command to the identification unit (1110 of FIG. 11) such that the identification unit (1110 of FIG. 11) identifies that EPB automatic engagement is performed.

The fourth identification operation (S1513c) may be performed after the third operation (S1513b) and before the fourth operation (S1514).

As another example, the fourth identifying operation (S1513c) may be performed in synchronization with the fourth operation (S1514).

In the fourth identification operation (S1513c), when it is determined that auto vehicle holding is not performed, the control unit (1106 in FIG. 11) may further transmit an identification command to the identification unit (1110 in FIG. 11) such that the identification unit (1110) identifies that auto vehicle holding is not performed.

Meanwhile, the control units 106, 506, 706, 906, 1006, and 1106 of the vehicle control apparatuses 100, 500, 700, 900, 1000, and 1100 according to the embodiments of the present invention may be implemented using an electronic control unit (ECU) (not shown) or a conventional micro control unit (MCU) (not shown) to control the overall operation of the vehicle.

However, the control units 106, 506, 706, 906, 1006, and 1106 are not limited thereto, and may be variously implemented using any other control device and determination device that can control and determine the overall operation of the vehicle.

As described above, when it is determined that the vehicle having been in a stationary state is moving and the transmission information corresponds to a neutral state, the vehicle control apparatuses 100, 500, 700, 900, 1000, and 1100 and the vehicle control methods (200, 300, 600 and 800), and (1200, 1300, 1400, and 1500) may transmit an EPB engagement command to the EPB devices 108, 508, 708, 908, 1008, and 1108 such that the EPB devices 108, 508, 708, 908, 1008, and 1108 perform EPB automatic engagement.

Accordingly, the vehicle control apparatuses 100, 500, 700, 900, 1000, and 1100 and the vehicle control methods (200, 300, 600, and 800), and (1200 1300, 1400, and 1500) according to the embodiments of the present invention may prevent fender bender by preventing the vehicle from being moved.

In addition, the vehicle control apparatus 500 and the vehicle control method (600) according to the embodiment of the present invention may further determine whether the braking value of the CB device 507 is kept for a preset target time or longer.

Accordingly, the vehicle control apparatus 500 and the vehicle control method 600 according to the embodiment of the present invention may prevent the vehicle from moving according to a braking intent of the driver, so that EPB automatic engagement of the EPB device 508 may be effectively performed.

In addition, when auto vehicle holding is not performed by the auto vehicle holding device 709, the vehicle control apparatus 700 and the vehicle control method (800) according to the embodiment of the present invention may further transmit an EPB engagement command to the EPB device 708 such that the EPB device 708 performs EPB automatic engagement.

Accordingly, the vehicle control apparatus 700 and the vehicle control method 800 according to the embodiment of the present invention may effectively prevent movement of the vehicle, thereby preventing a fender bender from occurring while further improving the reliability of the vehicle.

In addition, the vehicle control apparatuses 900 to 1100 and the vehicle control methods 1200 to 1500 according to the embodiment of the present invention may identify that EPB automatic engagement is performed and that auto vehicle holding is not performed.

Accordingly, the vehicle control apparatuses 900 to 1100 and the vehicle control methods 1200 to 1500 according to the embodiment of the present invention may improve the reliability of the vehicle by suppressing the anxiety over an EPB operating state felt by the driver, and remove increase in the maintenance cost by rapidly performing an initial response for maintenance of the auto vehicle holding device 1109.

As is apparent from the above, the vehicle control apparatus and method can prevent fender bender from occurring.

The vehicle control apparatus and method can effective perform EPB automatic engagement of an EPB device.

The vehicle control apparatus and method can improve the reliability of a vehicle by suppressing the anxiety over an EPB operation state felt by a driver.

The vehicle control apparatus and method can reduce increase in the maintenance cost by rapidly performing an initial response for maintenance of an auto vehicle holding device.

What is claimed is:

1. A vehicle control apparatus comprising:
a sensing unit configured to sense at least one of a vehicle speed value and a wheel speed value;
a transmission information output device configured to output transmission information; and
a control unit configured to determine whether a vehicle having been in a stationary state is moving using the sensed at least one of the vehicle speed value and the wheel speed value, determine whether the output transmission information corresponds to a neutral state when the vehicle having been in a stationary state is moving, and transmit an electrical parking brake (EPB) engagement command to an EPB device such that EPB automatic engagement is performed by the EPB device when the transmission information corresponds to a neutral state.

2. The vehicle control apparatus of claim 1, wherein the control unit, when determining whether the transmission information corresponds to a neutral state, determines whether the output transmission information corresponds to a set automatic transmission type neutral state.

3. The vehicle control apparatus of claim 1, wherein the control unit, when determining whether the transmission information corresponds to a neutral state, determines whether the output transmission information corresponds to a set manual transmission type neutral state.

4. The vehicle control apparatus of claim 1, wherein the control unit, when determining whether the vehicle having been in a stationary state is moving, determines whether the sensed at least one of the vehicle speed value and the wheel speed value is equal to a set target value corresponding thereto.

5. The vehicle control apparatus of claim 1, wherein the control unit further receives a braking value from a conventional brake (CB) device, and further determines whether the received braking value is kept for a preset target time or longer.

6. The vehicle control apparatus of claim 1, wherein the control unit further receives an accelerator pedal operation signal sensed by the sensing unit, and further determines whether an accelerator pedal is in a non-operation state using the received accelerator pedal operation signal.

7. The vehicle control apparatus of claim 6, wherein the control unit further receives a change value of longitudinal acceleration sensed by the sensing unit, and further determines whether a change in longitudinal acceleration exists using the received change value of longitudinal acceleration.

8. The vehicle control apparatus of claim 7, wherein the control unit further transmits an EPB engagement command to the EPB device such that EPB automatic engagement is performed by the EPB device when a change in longitudinal acceleration exists.

9. The vehicle control apparatus of claim 1, wherein the control unit further receives an auto vehicle holding operation signal from an auto vehicle holding device, and further determines whether auto vehicle holding is not performed using the received auto vehicle holding operation signal.

10. The vehicle control apparatus of claim 9, wherein the control unit further transmits an EPB engagement command to the EPB device such that EPB automatic engagement is performed by the EPB device when auto vehicle holding is not performed.

11. The vehicle control apparatus of claim 1, wherein the control unit further receives road surface information sensed by the sensing unit, and further determines whether a road surface has a gradient using the received road surface information.

12. A vehicle control method comprising:
sensing at least one of a vehicle speed value and a wheel speed value;
determining whether a vehicle having been in a stationary state is moving using the at least one of the vehicle speed value and the wheel speed value;
receiving transmission information output from a transmission information output device when the vehicle having been in a stationary state is moving;
determining whether the received transmission information corresponds to a neutral state; and
transmitting an electrical parking brake (EPB) engagement command to an EPB device such that EPB automatic engagement is performed by the EPB device when the transmission information corresponds to a neutral state.

13. The vehicle control method of claim 12, wherein the determining of whether the vehicle having been in a stationary state is moving includes determining whether the sensed at least one of the vehicle speed value and the wheel speed value is equal to a set target value corresponding thereto.

14. The vehicle control method of claim 12, further comprising:
receiving a braking value output from a conventional brake (CB) device when the vehicle having been in a stationary state is moving; and
determining whether the received braking value is kept for a preset target time or longer.

15. The vehicle control method of claim 12, further comprising:
receiving an accelerator pedal operation signal when the transmission information corresponds to a neutral state; and
determining whether an accelerator pedal is in a non-operation state using the sensed accelerator pedal operation signal.

16. The vehicle control method of claim 15, further comprising sensing a change value of longitudinal acceleration when the accelerator pedal is in a non-operation state; and
determining whether a change in longitudinal acceleration exists using the sensed change value of longitudinal acceleration.

17. The vehicle control method of claim 16, further comprising transmitting an EPB engagement command to the EPB device such that EPB automatic engagement is performed by the EPB device when a change in longitudinal acceleration exists.

18. The vehicle control method of claim 12, further comprising:
receiving an auto vehicle holding operation signal from an auto vehicle holding device when the transmission information corresponds to a neutral state; and
determining whether auto vehicle holding is not performed using the received auto vehicle holding operation signal.

19. The vehicle control method of claim 18, further comprising transmitting an EPB engagement command to the EPB device such that EPB automatic engagement is performed by the EPB device when auto vehicle holding is not performed.

20. The vehicle control method of claim 12, further comprising:
receiving road surface information before the determining of whether the vehicle having been in a stationary state is moving; and
determining whether a road surface has a gradient using the sensed road surface information.
